(19) United States
(12) Patent Application Publication
(10) Pub. No.: US 2007/0132960 A1
(43) Pub. Date: Jun. 14, 2007

(54) LIQUID CRYSTAL PANEL AND PROJECTOR TYPE DISPLAY DEVICE

(75) Inventors: Koichi TERAO, Suwa (JP); Shohei YOSHIDA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 11/548,119

(22) Filed: Oct. 10, 2006

(30) Foreign Application Priority Data
Oct. 11, 2005 (JP) 2005-295968
Jun. 21, 2006 (JP) 2006-171006

(51) Int. Cl. G03B 21/00

(52) U.S. Cl. 353/31

(57) ABSTRACT

A liquid crystal panel to be demountably mounted to a projector type display device having a light source for emitting light and a light collecting unit collecting a plurality of single color lights out of the light emitted from the light source at a position between the light source and the light collecting unit, the liquid crystal panel includes a plurality of light transmitting areas for allowing the respective single color lights to pass through in the state of being mounted to the projector type display device, wherein the plurality of light transmitting areas are arranged and connected or integrated in the direction of substantially the same plane of the liquid crystal panel.

### BACKGROUND

1. Technical Field

The invention relates to a liquid crystal panel and a projector type display device.

2. Related Art

A projector type display device that projects an image on a screen is known. In the projector type display device, a liquid crystal panel (liquid crystal shutter) is mainly employed for forming the image. As such a projector type display device, for example, a device disclosed in JP-A-11-218746 is known.

The projector type display device in JP-A-11-218746 includes a dichroic prism and three liquid crystal panels installed in three different directions of the dichroic prism. The projector type display device is configured in such a manner that red light, green light and blue light passed through the respective liquid crystal panels are collected by the dichroic prism and the collected light is projected as an image.

Generally, in the projector type display device, for examples the liquid crystal panel is deteriorated under the usage conditions such as the duration of service or the environment of usage, and hence a deterioration of display quality, such as a deterioration of contrast may be resulted. Therefore, it is necessary to replace the deteriorated (used) liquid panel with a new liquid crystal panel. However, in the projector type display device disclosed in JP-A-11-218746, there is such a problem that when the deteriorated liquid crystal panel is replaced, since replacement is made for the three liquid crystal panels, the replacement work may become complicated.

In addition, since it is necessary to perform the positioning work for each liquid crystal panel after three new liquid crystal panels are installed, the positioning work is also disadvantageously complicated.

### SUMMARY

An advantage of some aspects of the invention is to provide a liquid crystal panel which can be replaced easily and a projector type display device in which such the liquid crystal panel can be mounted.

The advantage as described above is achieved by the invention as described below.

A liquid crystal panel according to an aspect of the invention is a liquid crystal panel to be demountably mounted to a projector type display device having a light source for emitting light and a light collecting unit collecting a plurality of single color lights out of the light emitted from the light source at a position between the light source and the light collecting unit, the liquid crystal panel including a plurality of light transmitting areas for allowing the respective single color lights to pass through in the state of being mounted to the projector type display device, and the plurality of light transmitting areas are arranged and connected or integrated in the direction of substantially the same plane of the liquid crystal panel.

Accordingly, since the liquid crystal panel is configured so that the respective light transmitting areas can be demountably mountable simultaneously with respect to the projector type display device, replacement of the liquid crystal panel can be performed easily.

Preferably, the plurality of single color lights are respectively red color, green color and blue color, and three of the light transmitting areas are provided corresponding to the respective lights.

Accordingly, the red light, the green light and the blue light are reliably passed through the respective light transmitting areas in the mounted state, and hence a clear image can be obtained.

Preferably, the liquid crystal panel is formed into an elongated shape in its entirety.

Accordingly, the replacement of the liquid crystal panel is further facilitated.

Preferably, the plurality of light transmitting areas are arranged in a row along the longitudinal direction of the liquid crystal panel.

Accordingly, the respective single color lights reliably pass through the respective light transmitting areas in the mounted state, and hence a clear image can be obtained.

Preferably, the plurality of light transmitting areas are arranged in a staggered.

Accordingly, the respective single color lights reliably pass through the respective light transmitting areas in the mounted state, and hence a clear image can be obtained.

Preferably, the liquid crystal panel is formed into an elongated shape in its entirety, and the mounting direction thereof substantially corresponds to the longitudinal direction of the liquid crystal panel.

Accordingly, insertion and pull-out of the liquid crystal panel with respect to a mounting portion is facilitated, and hence the replacement of the liquid crystal panel can further be facilitated.

Preferably, the liquid crystal panel is operated on the basis of image signal from the projector type display device and an image is formed thereby.

Accordingly, a desired image can be obtained.

The projector type display device according to an aspect of the invention is a projector type display device in which a liquid crystal panel having a plurality of light transmitting areas through which a plurality of single color lights pass respectively is mounted, the plurality of light transmitting areas being arranged and connected or integrated in the direction of substantially the same plane, including: a light source for emitting light; a light collecting unit collecting a plurality of single color lights out of light emitted from the light source; and a mounting portion provided between the light source and the light collecting unit mounting the liquid crystal panel so as to be mountable and demountable.

Accordingly, the replacement of the liquid crystal panel can be facilitated.

Preferably, the light source includes a plurality of single color light sources which emit single color lights being different in wavelength from each other.

Accordingly, the respective single color lights reliably pass through the liquid crystal panel respectively.

Preferably, the light source emits white light, and a light splitting unit installed so as to oppose the light collecting unit via the mounting portion for splitting the white light emitted from the light source into a plurality of single color lights is provided.

Accordingly, the white light can reliably be split into the plurality of single color lights.

Preferably, the mounting portion includes a positioning unit that determines the position of the liquid crystal panel mounted to the mounting portion with respect to the light splitting unit and/or the light collecting unit, respectively.

Accordingly, when the liquid crystal panel is brought into the state of being mounted on the mounting portion, the plurality of light transmitting areas are reliably positioned with respect to the light splitting unit or the light collecting unit simultaneously.

Preferably, the light splitting unit includes a plurality of dichroic mirrors corresponding to the respective single color lights and the dichroic mirrors are connected or integrated.

Accordingly, the positional relation between the dichroic mirrors in the light splitting unit in itself is reliably fixed, and hence the light incoming into the light splitting unit can reliably be split.

Preferably, the light splitting unit includes a first dichroic mirror group having a plurality of dichroic mirrors corresponding to the respective single color lights and the dichroic mirrors being connected or integrated, the light collecting unit includes a second dichroic mirror group having a plurality of dichroic mirrors corresponding to the respective single color lights and the dichroic mirrors being connected or integrated, and the first dichroic mirror group and the second dichroic mirror group are arranged so that the lengths of the optical paths of the plurality of single color lights become the same.

Accordingly the difference in length of the optical path of the plurality of single color lights is reliably solved, and hence a clear image can be obtained.

Preferably, the light source includes a light-emitting diode.

Accordingly, the number of times of repair or replacement of the single color light source required, for example, due to failure, that is, MTBF (mean time between failures) or MTTF (mean time to failure) of the single color light source can be set to a relatively long time.

Preferably, a plurality of the light-emitting diodes are provided and are arranged in rows and columns.

Accordingly, the light from the plurality of light emitting diode can be irradiated uniformly on the liquid crystal panel, and hence a clear image can be obtained.

Preferably, the plurality of single color lights are red light, green light and blue light, respectively.

Accordingly, red light, green light and blue light reliably pass through the respective light transmitting areas in the mounted state, and hence a clear image can be obtained.

Preferably, the mounting portion includes a frame-shaped mounting portion main body for supporting the liquid crystal panel mounted to the mounting portion, and a guide portion formed along the mounting portion main body along the direction of mounting the liquid crystal panel for guiding the liquid crystal panel in this direction.

Accordingly, the replacement of the liquid crystal panel can be facilitated.

Preferably, the mounting portion includes a friction alleviating unit alleviating friction between the liquid crystal panel and the guide portion when the liquid crystal panel is mounted.

Accordingly, insertion and pull-out of the liquid crystal panel with respect to the mounting portion is facilitated, and hence the replacement of the liquid crystal panel can be facilitated.

Preferably, the light collecting unit includes a plurality of dichroic mirrors corresponding to the respective single color lights, and the dichroic mirrors are connected or integrated.

Accordingly, the positional relation between the dichroic mirrors in the light collecting unit in itself is reliably fixed, and hence light entering the light collecting unit can reliably be collected.

Preferably, an optical path length adjusting unit adjusting the length of the optical path is provided so that the lengths of the optical paths of the plurality of single color lights become the same.

Accordingly, the difference in length of the optical paths of the plurality of single color lights is reliably solved, and hence a clear image can be obtained.

### BRIEF DESCRIPTION OF THE DRAWINGS

The invention will be described with reference to the accompanying drawings, wherein like numbers reference like elements.

FIG. 1 is a pattern diagram of an optical system of a projector type display device (first embodiment) according to an aspect of the invention.

FIG. 2 is a perspective view of a mounting portion of the projector type display device shown in FIG. 1 and a liquid crystal panel mounted to the mounting portion (first embodiment).

FIG. 3 is an exploded perspective view of the mounting portion and the liquid crystal panel shown in FIG. 2.

FIG. 4 is a pattern diagram of the liquid crystal panel in FIG. 2 shown in cross section.

FIG. 5 is a pattern perspective view of a light splitting unit, a light collecting unit and the liquid crystal panel (second embodiment) of the projector type display device (second embodiment) according to an aspect of the invention.

FIG. 6A, FIG. 6B and FIG. 6C illustrate three views of the light splitting unit, the light collecting unit and the liquid crystal panel shown in FIG. 5, in which FIG. 6A is a plan view viewed in the direction of an arrow A in FIG. 5, FIG. 6B is a front view viewed in the direction of an arrow B in FIG. 5, and FIG. 6C is a side view viewed in the direction of an arrow C in FIG. 5).

FIG. 7 is a pattern diagram of an optical system of the projector type display device (third embodiment) according to an aspect of the invention.

FIG. 8 is a plan view of a light source of the projector type display device shown in FIG. 7.

FIG. 9 is a pattern perspective view showing the light collecting unit, the liquid crystal panel, and the light source of the projector type display device (fourth embodiment) according to an aspect of the invention.

### DESCRIPTION OF EXEMPLARY EMBODIMENTS

Referring now to the attached drawings, a liquid crystal panel and a projector type display device according to an aspect of the invention will be described in detail.

### First Embodiment

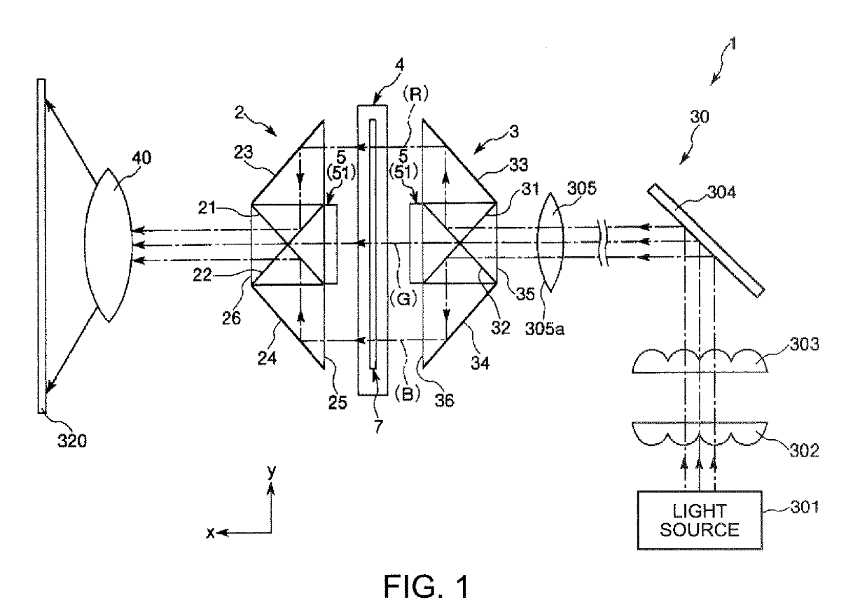

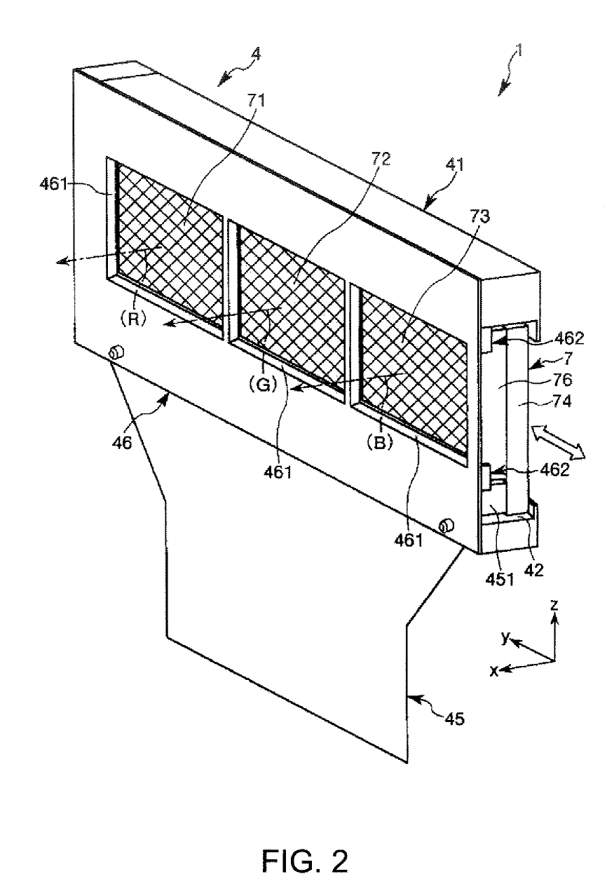

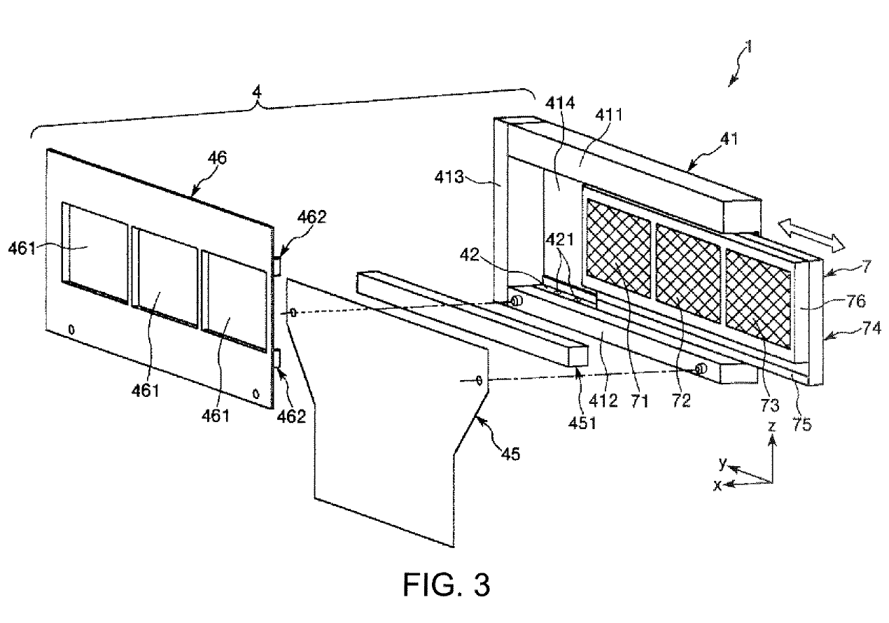

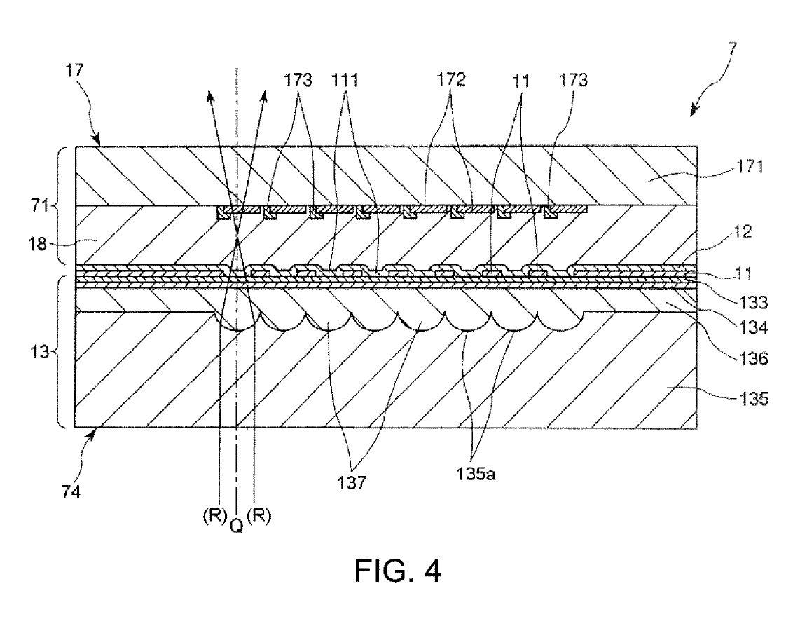

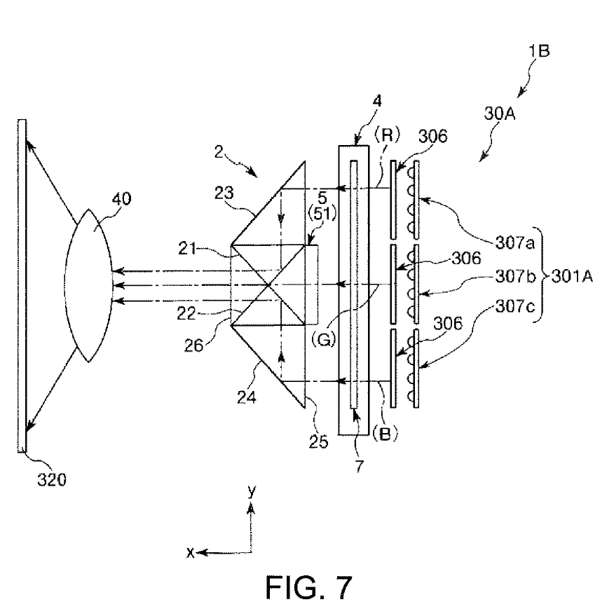

FIG. 1 is a pattern diagram of an optical system of a projector type display device (first embodiment) according to an aspect of the invention; FIG. 2 is a perspective view of a mounting portion of the projector type display device shown in FIG. 1 and a liquid crystal panel mounted to the mounting portion (first embodiment); FIG. 3 is an exploded perspective view of the mounting portion and the liquid crystal panel shown in FIG. 2; and FIG. 4 is a cross-sectional pattern diagram of the liquid crystal panel shown in FIG. 2. The lateral direction in FIG. 1 (the same in FIG. 7) is referred to as the x-axis direction, and the direction vertical to the x-axis direction, that is, the upward/downward direction in FIG. 1 is referred to as the y-axis direction. The upper side in FIG. 2 and FIG. 3 is referred to as “up” or “upward” and the lower side is referred to as “down” or “downward”. The upward/downward direction in FIG. 2 and FIG. 3 is referred to as the z-axis direction.

A projector type display device 1 according to an aspect of the invention shown in FIG. 1 is adapted so that a liquid crystal panel 7 according to an aspect of the invention is mounted. A state in which the liquid crystal panel 7 is mounted to the projector type display device 1 (mounting portion 4) is referred to as “mounted state” hereinafter.

As shown in FIG. 1, the projector type display device 1 includes an illumination optical system 30, a light splitting unit 3 for splitting a white light from the illumination optical system 30 into three (a plurality of) single color lights, a light collecting unit 2 for collecting the three single color lights split by the light splitting unit 3, the mounting portion 4 to which the liquid crystal panel 7 is demountably mounted, an optical path length adjusting unit 5, and a projecting lens (projection optical system) 40.

As shown in FIG. 2 and FIG. 3, the liquid crystal panel 7 is formed into an elongated shape (plate-shape (for example, a rectangular shape in plan view). The liquid crystal panel 7 includes a panel substrate 74, and light transmitting areas 71, 72 and 73 through which the respective single color lights pass through in the mounting state.

The projector type display device 1 will be described first.

The illumination optical system 30 includes a light source 301, integrator lenses 302 and 303, a mirror 304 and a light collecting lens 305.

The light source 301 emits white light (white luminous flux) in the y-axis positive direction.

The integrator lenses 302 and 303 are arranged on the white light outgoing side of the light source 301.

The integrator lenses 302 and 303 are opposed so as to allow the white light to pass through, respectively. Accordingly, the white light passed through the integrator lenses 302 and 303 is uniformized in light strength (luminance distribution).

The mirror 304 is provided on the white light outgoing side of the integrator lens 303. The mirror 304 is provided so that the mirror surface is inclined by 45° with respect to the x-axis direction and the y-axis direction respectively. Accordingly, the white light passed through the integrator lenses 302 and 303 reflects from the mirror 304 leftward in FIG. 1 (in the x-axis positive direction) and proceeds to the light collecting lens 305.

The light collecting lens 305 is provided on the white light outgoing side (reflecting direction) of the mirror 304. The white light passed through the light collecting lens 305 is shaped by the light collecting lens 305 and enters the light splitting unit 3.

The light splitting unit 3 is provided on an outgoing surface 305a side of the light collecting lens 305. The light splitting unit 3 is a portion to split the white light emitted from the light source 301 and passed through the integrator lenses 302 and 303, the mirror 304 and the light collecting lens 305 in sequence into the three single color lights. In the projector type display device 1, the split three single color lights are red light (R), green light (G) and blue light (B), respectively.

As shown in FIG. 1, the light splitting unit 3 includes dichroic mirrors 31 and 32, and the mirrors 33 and 34.

The dichroic mirror 31 is a mirror which reflects only blue light (B) (allows red right (R) and green light (G) to pass through).

The dichroic mirror 31 is arranged on the opposite side of the light collecting lens 305 via an incident surface 35 to which the white light from the light splitting unit 3 enters (vertical to the x-axis direction). The dichroic mirror 31 is disposed so as to incline by 45° in FIG. 1 with respect to the incident surface 35 of the light splitting unit 3.

With the dichroic mirror 31 in this arrangement, only blue light (B) reflects in the y-axis negative direction.

The dichroic mirror 32 is a mirror which reflects only red light (R) (allows green light (G) and blue light (B) to pass through).

The dichroic mirror 32 is disposed so that the midsection thereof is oriented orthogonally to the midsection of the dichroic mirror 31. Accordingly, only red light (R) reflects in the y-axis positive direction.

The mirror 33 is provided on the opposite side of the dichroic mirror 32 in a posture parallel to the dichroic mirror 32. Accordingly, the red light (R) reflected from the dichroic mirror 32 is reflected from the mirror 33 in the x-axis positive direction, and emitted from an outgoing surface 36.

The red light (R) emitted from the outgoing surface 36 passes through the light transmitting area 71 on the liquid crystal panel 7 in the mounted state (see FIG. 2).

The mirror 34 is provided on the opposite side of the dichroic mirror 31 in a posture parallel to the dichroic mirror 31. Accordingly, the blue light (B) reflected from the dichroic mirror 31 is reflected from the mirror 34 in the x-axis positive direction and emitted from the outgoing surface 36.

The blue light (B) emitted from the outgoing surface 36 passes through the light transmitting area 73 on the liquid crystal panel 7 in the mounted state (see FIG. 2).

In the light splitting unit 3, green light (G) passes through the dichroic mirrors 31 and 32 and is emitted from the outgoing surface 36. Then the green light (G) emitted from the outgoing surface 36 passes through the transmitting area 72 of the liquid crystal panel 7 in the mounted state (see FIG. 2).

In the light splitting unit 3 in this arrangement, preferably, the dichroic mirrors 31 and 32 are connected or integrated with the mirrors 33 and 34 (first dichroic mirror group).

Accordingly, the positional relation between the mirrors in the light splitting unit 3 in itself is reliably fixed, and hence the white light incoming into the light splitting unit 3 can be split reliably. The light splitting unit 3 is unitized, and hence assembly of the light splitting unit 3 in itself into the projector type display device 1 is facilitated. In other words, assembly (manufacture) of the projector type display device 1 is facilitated.

As shown in FIG. 1, the light collecting unit 2 is disposed at a position opposing the light splitting unit 3 on the outgoing surface 36 side of the light splitting unit 3 via the mounting portion 4. The light collecting unit 2 is a portion that collects red light (R), green light (G) and blue light (B) split by the light splitting unit 3.

The light collecting unit 2 includes dichroic mirrors 21 and 22, and mirrors 23 and 24.

The mirror 23 is provided at a position corresponding to the mirror 33 of the light splitting unit 3 via an incident surface 25 vertical to the x-axis direction of the light collecting unit 2 (the opposite side of the light splitting unit 3 from the mirror 33). The mirror 23 is disposed so as to incline by 45° in FIG. 1 with respect to the incident surface 25, that is, so as to incline by 90° with respect to the mirror 33 of the light splitting unit 3.

The red light (R) emitted from the outgoing surface 36 of the light splitting unit 3 is reflected by the mirror 23 arranged in this manner in the y-axis negative direction by the mirror 23, and enters the dichroic mirror 22.

The dichroic mirror 22 is a mirror which reflects only red light (R) (allows green light (G) and blue light (B) to pass through). The dichroic mirror 22 is disposed on the opposite side of the mirror 23 in a posture in parallel to the mirror 23. Accordingly, the red light (R) reflected from the dichroic mirror 22 is reflected in the x-axis positive direction, and emits from the outgoing surface 26.

The red light (R) emitted from the outgoing surface 26 proceeds to a projecting lens 40.

The mirror 24 is provided at a position corresponding to the mirror 34 of the light splitting unit 3 via the incident surface 25 of the light collecting unit 2 (the opposite side of the light splitting unit 3 from the mirror 34). The mirror 24 is disposed so as to incline by 90° in FIG. 1 with respect to the mirror 23, that is, so as to incline by 90° with respect to the mirror 34 of the light splitting unit 3.

The blue light (B) emitted from the outgoing surface 36 of the light splitting unit 3 is reflected by the mirror 24 arranged in this manner in the y-axis positive direction by the mirror 24, and enters the dichroic mirror 21.

The dichroic mirror 21 is a mirror that reflects only blue light (B) (allow red light (R) and green light (G) to pass through).

The dichroic mirror 21 is provided on the opposite side of the mirror 24 in a posture in parallel to the mirror 24. The dichroic mirror 21 is disposed so that the midsection thereof is oriented orthogonally to a midsection of the dichroic mirror 22.

Accordingly, the blue light (B) reflected from the dichroic mirror 21 is reflected in the x-axis positive direction, and emitted from the outgoing surface 26.

The blue light (B) emitted from the outgoing surface 26 proceeds to the projection lens 40.

In the light collecting unit 2, green light (G) passes through the dichroic mirrors 21 and 22, and emitted from the outgoing surface 26. The green light emitted from the outgoing surface 26 proceeds to the projecting lens 40.

In the light collecting unit 2 in this arrangement, preferably, the dichroic mirrors 21 and 22 are connected or integrated with the mirrors 23 and 24 (second dichroic mirror group).

Accordingly, the positional relation between the mirrors in the light collecting unit 2 in itself is reliably fixed, and hence the red light (R), the green light (G) and the blue light (B) incoming into the light collecting unit 2 are collected reliably. The light collecting unit 2 in itself is unitized, and hence assembly of the light collecting unit 2 into the projector type display device 1 is facilitated. In other words, assembly (manufacture) of the projector type display device 1 is facilitated.

As shown in FIG. 1, the mounting portion 4 to which the liquid crystal panel is mounted is provided between the light splitting unit 3 and the light collecting unit 2.

As shown in FIG. 2 and FIG. 3, the mounting portion 4 includes a mounting portion main body 41, a guide portion (guide groove) 42 for guiding the liquid crystal panel 7, a circuit board 45, a cover 46 and a friction alleviating unit.

The mounting portion main body 41 is formed of an angular C-shaped (frame-shaped) member for supporting the liquid crystal panel 7 in the mounted state.

The mounting portion main body 41 is configured in such a manner that the shape (size) of a space 414 surrounded by opposed two sides 411 and 412 and a side 413 which connects them is set to be substantially the same as the contour of the liquid crystal panel 7. Accordingly, the liquid crystal panel 7 in the mounted state can be supported reliably.

The guide portion 42 is formed along the longitudinal direction (in the direction of mounting the liquid crystal panel 7 of the mounting portion main body 41) of the side 412 on the upper side of the mounting portion main body 41.

When the liquid crystal panel 7 is mounted to the mounting portion 4, the guide portion 42 guides the liquid crystal panel 7 along the direction of formation thereof. Accordingly, the insertion and pull-out of the liquid crystal panel 7 with respect to the mounting portion 4 are facilitated, and hence replacement of the liquid crystal panel 7 is further facilitated.

As shown in FIG. 3, the direction of mounting the liquid crystal panel 7 with respect to the projector type display device 1 substantially matches the longitudinal direction of the liquid crystal panel 7. Accordingly, the insertion and pull-out of the liquid crystal panel 7 with respect to the mounting portion 4 are facilitated, and hence the replacement of the liquid crystal panel 7 can further be facilitated.

Positioning of the liquid crystal panel 7 in the mounted state in the x-axis direction and the upward/downward direction in FIG. 2 with respect to the light splitting unit 3 and the light collecting unit 2 respectively is achieved by a lower portion of the liquid crystal panel 7 barged into the guide portion 42.

In this manner, the guide portion 42 serves as a positioning unit positioning the liquid crystal panel 7 in the mounted state in the x-axis direction and in the vertical direction in FIG. 2 with respect to the light splitting unit 3 and the light collecting unit 2 respectively.

As shown in FIG. 3, a plurality of rollers 421 are provided along the bottom portion (the y-axis direction) on a bottom portion (lower portion) of the guide portion 42. The respective rollers 421 serve as the friction alleviating unit alleviating the friction between the liquid crystal panel 7 and the guide portion 42 generated when the liquid crystal panel 7 is mounted.

With the rollers 421 as described above, the insertion and pull-out of the liquid crystal panel 7 with respect to the mounting portion 4 are further facilitated, and hence the replacement of the liquid crystal panel 7 is further facilitated.

The plurality of rollers 421 are preferably arranged at regular intervals. Accordingly, the liquid crystal panel 7 can be moved smoothly. Therefore, the insertion and pull-out of the liquid crystal panel 7 with respect to the mounting portion 4 are further facilitated, and hence the replacement of the liquid crystal panel 7 is further facilitated.

The friction alleviating unit is not limited to those composed of the plurality of rollers 421 and, for example, may be the guide portion 42 provided with Teflon® coating on the bottom portion thereof.

The circuit board 45 is provided on a lower portion of the mounting portion main body 41. The circuit board 45 is electrically connected to a control unit (not shown) of the projector type display device 1, and is a board for driving the liquid crystal panel 7 in the mounted state on the basis of the image signal from the control unit (projector type display device 1).

The circuit board 45 is provided with a terminal portion 451 electrically connected to a terminal portion 75 of the liquid crystal panel 7 in the mounted state. The terminal portion 451 is formed of, for example, an anisotropic conductive rubber.

The cover 46 is formed into a rectangular plate shape, and is mounted so as to cover the front face of the mounting portion main body 41 (the surface on the light collecting unit 2).

The cover 46 is provided with openings 461 corresponding to light transmitting areas 71, 72 and 73 of the liquid crystal panel 7 in the mounted state. As shown in FIG. 2, the light transmitting areas 71, 72 and 73 of the liquid crystal panel 7 in the mounted state are exposed from the respective openings 461.

The cover 46 is provided with a pair of claws 462 so as to project from an edge on the back surface of the cover 46 (the surface on the side of the mounting portion main body 41). The claws 462 are provided so as to be apart from each other in the width direction of the cover 46. The respective claws 462 are urged, for example, by a compressed coil spring (not shown) in the x-axis negative direction.

The pair of claws 462 as described above engages an edge 76 of the liquid crystal panel 7 in the mounted state and presses the liquid crystal panel 7 in the x-axis negative direction. Accordingly, the positioning in the y- and z-axis directions in FIG. 2 is achieved with respect to the light splitting unit 3 and the light collecting unit 2, respectively.

The edge 76 of the liquid crystal panel 7 may be provided with recesses which correspond to the respective claws 462. Accordingly, the respective claws 462 engages the recesses on the edge 76 in the mounted state, whereby the liquid crystal panel 7 is reliably prevented from coming off the mounting portion 4 involuntarily.

The mounting portion 4 may be provided with a releasing mechanism for releasing engagement between the respective claws 462 and the recesses on the edge 76 in the mounted state. Accordingly, the replacement of the liquid crystal panel 7 can be facilitated.

The number of claws 462 to provide is not limited to two, and, for example, three or more claws may be provided.

Although the shape of the claw 462 is not specifically limited, for example, a wedge shape or a block shape may be exemplified.

As described above, the guide portion 42 and the respective claws 462 serve as the positioning unit positioning the liquid crystal panel 7 in the mounted state with respect to the light splitting unit 3 and the light collecting unit 2, respectively.

Accordingly, when the liquid crystal panel 7 is brought into the mounted state, the light transmitting areas 71, 72 and 73 are simultaneously positioned reliably with respect to the light splitting unit 3 and the light collecting unit 2. Accordingly, the replacement of the liquid crystal panel 7 is performed quickly and easily.

Since the light transmitting areas 71, 72 and 73 are positioned simultaneously, individual positioning for the light transmitting areas 71, 72 and 73 can be omitted. Accordingly, the replacement of the liquid crystal panel 7 can be performed quickly and easily.

As shown in FIG. 1, the length of the optical path in the projector type display device 1 is the same for red light (R), blue light (B) and the lengths of the optical path are different between red light (R) (and the blue light (B)) and green light (G).

Therefore in order to solve the fact that the difference in length of the optical path of red right (R) and green light (C), that is, to equalize the lengths of the optical path for red light (R) and green light (G), the optical path length adjusting unit 5 adjusting the length of the optical path for green light (G) is provided in the projector type display device 1.

The optical path length adjusting unit 5 is composed for example of a relay lens 51, and includes the one provided at a portion of the outgoing surface 36 where green light (G) goes out, and the one provided at a portion of the incident surface 25 where the green light (G) enters.

With the optical path adjusting unit 5 as such, the difference in length of the optical path between red light (R) and green light (G) is reliably resolved, and hence a clear image can be obtained.

Subsequently, the liquid crystal panel 7 will be described.

The liquid crystal panel 7 shown in FIG. 1 to FIG. 3 is operated on the basis of the image signal from the projector type display device 1 to form the image thereby. As described above, the liquid crystal panel 7 is demountably mounted to the mounting portion 4 of the projector type display device 1.

The liquid crystal panel 7 includes a panel substrate 74, and the light transmitting areas 71, 72 and 73 through which the single color lights (R), (G) and (B) are respectively passed through in the mounted state.

The panel substrate 74 is formed into an elongated shape in its entirety. Accordingly, the liquid crystal panel 7 can be held easily, and hence the replacement of the liquid crystal panel 7 can be facilitated.

As shown in FIG. 4, the panel substrate 74 includes a micro-lens substrate 13, a black matrix 11 being provided on a barrier layer 133 of the micro-lens substrate 13 and having an opening 111 thereon, and a transparent conductive film (common electrode) 12 provided so as to cover the black matrix 11 on the barrier layer 133.

The micro-lens substrate 13 includes a transparent substrate 135, and a micro-lens forming layer 136 provided on the transparent substrate 135. The micro-lens forming layer 136 is formed with a number of micro-lenses 137 with resin which constitutes the micro-lens forming layer 136

The transparent substrate 135 is a portion which functions as a base member of the micro-lens substrate 13.

The transparent substrate 135 is formed with a plurality of recesses 135a having a curved recessed surfaces on one surface (the upper surface in FIG. 4). Then, by providing the micro-lens forming layer 136 on a surface of the transparent substrate 135 on which the recesses 135a are formed, resin which constitutes the micro-lens forming layer 136 is filled in the recesses 135a, and the micro lenses 137 in the curved projecting shape are formed. A predetermined numbers of the micro lenses 137 are arranged in a predetermined arrangement (for example, in rows).

The micro-lens forming layer 136 is provided with the barrier layer 133 via an intermediate layer (base layer) 134 thereon.

The intermediate layer 134 is formed for various objects, and may be provided for improving adhesiveness of the barrier layer 133 as an example. The intermediate layer 134 is preferably formed of high-polymer material and, in particular, thermosetting resin such as benzo cyclo-butene resin, polyimide and epoxy resin, or thermoplastic resin such as acryl-contained composite resin (containing alkylene glycol mono-alkyl acetate, acryl resin, and other sensory acryl monomer) are preferable. Out of these elements, the benzo-cyclo-butene resin and the acryl-contained composite resin are preferable.

Such the intermediate layer 134 is provided with the barrier layer 133 formed, for example, of a thin film thereon. Accordingly, the transition of water content or an organic content with respect to the micro-lens forming layer 136 can be prevented.

The transparent conductive film 12 has conductivity, and is formed of, for example, indium tin oxide (ITO), indium oxide (IO), stannic oxide (SnO₂), or zinc oxide (ZnO).

The terminal portion 75 is formed into a band shape on the lower portion of the panel substrate 74, so as to be electrically connected to the light transmitting areas 71 72 and 73 (a TFT substrate 17). The terminal portion 75 includes terminals corresponding to the respective pixels of the light transmitting areas 71, 72 and 73, and is composed by an assembly of these terminals. The terminal portion 75 in this configuration is electrically connected to the terminal portion 451 of the circuit board 45, and corresponding terminals of the terminal portion 75 and the terminal portion 451 are electrically connected to each other in the mounted state.

The light transmitting areas 71, 72 and 73 are substantially the same in configuration, the light transmitting area 71 is described as a representative.

The light transmitting area 71 is an area of substantially a rectangular shape in plan view.

As shown in FIG. 4, the light transmitting area 71 includes the TFT substrate (liquid crystal drive substrate) 17 joined to the panel substrate 74, and a liquid crystal layer 18 composed of liquid crystal encapsulated in a gap between the TFT substrate 17 and the panel substrate 74.

The TFT substrate 17 is a substrate for driving the liquid crystal of the liquid crystal layer 18, and includes a glass substrate 171, a number of individual electrodes 172 provided on the glass substrate 171, and a number of thin-film transistors (TFT) 173 corresponding to the respective individual electrodes 172 provided in the vicinity of the individual electrodes 172.

In the liquid crystal panel 7, the TFT substrate 17 and the panel substrate 74 are joined at a predetermined distance so that the transparent conductive film 12 of the panel substrate 74 and the individual electrodes 172 of the TFT substrate 17 are opposed to each other.

The glass substrate 171 is formed, for example, of quartz glass or the like.

The individual electrodes 172 drive the liquid crystal of the liquid crystal layer 18 by charging and discharging electricity with respect to the transparent conductive film (common electrode) 12. The individual electrode 172 is formed, for example, of a material which is the same as that of the aforementioned transparent conductive film 12.

The thin-film transistor 173 is connected to the corresponding individual electrode 172 located in the vicinity thereof. The thin-film transistor 173 is connected to the projector type display device 1 via the terminal portion 75 and the terminal portion 451 of the mounting portion 4, and controls the current to be supplied to the individual electrode 172 in the mounted state. Accordingly, charging and discharging of the individual electrodes 172 are controlled.

The liquid crystal layer 18 contains liquid crystal elements (not shown), and the orientation of the liquid crystal elements, that is, the liquid crystal is changed according to the charging and discharging of the individual electrodes 172.

Generally, in the liquid crystal panel 7, one micro-lens 137, one opening 111 of the black matrix 11 corresponding to an optical axis Q of the micro-lens 137, one of the individual electrodes 172, and one of the thin-film transistor 173 connected to the individual electrode 172 correspond to one pixel.

In the liquid crystal panel 7 in this configuration, red light (R) entered from the panel substrate 74 side passes through the transparent substrate 135, is collected while passing through the micro-lens 137 (micro-lens forming layer 136), and passes through the intermediate layer 134, the barrier layer 133, the opening 111 of the black matrix 11, the transparent conductive film 12, the liquid crystal layer 18, the individual electrode 172 and the glass substrate 171. At this time, the respective pixels of the light transmitting area 71 is controlled to be switched (ON/OFF) by driving the TFT substrate 17 which is operated on the basis of an image signal for red light, that is, modulated. Accordingly, the red light (R) is modulated in the light transmitting area 71, and hence an image for red color is formed.

As shown in FIG. 2 and FIG. 3, the light transmitting areas 71, 72 and 73 are arranged in a row on substantially the same plane of the panel substrate 74 (liquid crystal panel 7), that is, along the longitudinal direction of the panel substrate 74. Accordingly, red light (R) is reliably passed through the light transmitting area 71, green light (G) is reliably passed through the light transmitting area 72, and blue light (B) is reliably passed through the light transmitting area 73 in the mounted state. Therefore, a clear image can be obtained.

In the liquid crystal panel 7, the light transmitting areas 71, 72 and 73 are connected or integrated. Accordingly, the liquid crystal panel 7 is configured in such a manner that the light transmitting areas 71, 72 and 73 can be demountably mounted to the mounting portion 4 simultaneously, so that the replacement of the liquid crystal panel 7 can be facilitated.

As described above, the light transmitting areas 71, 72 and 73 are formed into a rectangular shape respectively, and are arranged in a row along the longitudinal direction of the panel substrate 74. In this case, the light transmitting areas 71, 72 and 73 may be arranged so that the longitudinal sides are adjacent to each other, or so that the shorter sides are adjacent to each other.

The replacement of the liquid crystal panel 7 is not limited to the replacement of the deteriorated liquid crystal panel 7 by the new liquid crystal panel 7, and the cases shown below are also applicable.

For example, there is a case of providing a plurality of liquid crystal panels 7 having different numbers of pixels from each other for changing (replacing) them depending on the usage. In this case, the quality of projected image can be changed. The duration of usage of the respective liquid crystal panels 7 is reduced in comparison with the case in which one liquid crystal panel 7 is continuously used, so that the lifetime of one liquid crystal panel 7 can be increased. When the plurality of liquid crystal panels 7 having the different numbers of pixels from each other are used depending on the case, the number of terminals of the terminal portion 75 of the respective liquid crystal panels 7 is different from each other. However, since the terminal portion 451 of the mounting portion 4 (circuit substrate 45) is formed of the anisotropic conductive rubber as described above, it can cope with the different number of terminal.

There is also a case in which the liquid crystal panel 7 is damaged.

Subsequently, the operation of the projector type display device 1 in the mounted state will be described.

Firstly, the liquid crystal panel 7 is mounted to the mounting portion 4 to bring the projector type display device 1 in the mounted state.

White light (white luminous flux) emitted from the light source 301 passes through the integrator lenses 302 and 303. The light intensity (luminous distribution) of the white light is uniformized by the integrator lenses 302 and 303.

The white light passed through the integrator lenses 302 and 303 reflects leftward in FIG. 1 by the mirror 304, and the reflected light is shaped by the light collecting lens 305 and enters the light splitting unit 3.

The white light entered into the light splitting unit 3 is split into red light (R), green light (G) and blue light (B) as described above.

The split red light (R), green light (B) and blue light (B) respectively enter the light transmitting areas 71, 72 and 73 of the liquid crystal panel 7.

In this case, the respective pixels of the light transmitting area 71 is controlled to be switched (ON/OFF) by driving the TFT substrate 17 which is operated on the basis of the image signal for red color, that is modulated. In the same manner, the respective pixels of the light transmitting area 72 are controlled to be switched (ON/OFF) by driving the panel substrate 74 which is operated on the basis of the image signal for green color, and the respective pixels of the light transmitting area 73 are controlled to be switched (ON/OFF) by driving the panel substrate 74 which is operated on the basis of the image signal for blue color.

Accordingly, the red light (R), the green light (G) and the blue light (B) are modulated by the light transmitting areas 71, 72 and 73 respectively, and the image for the red color, the image for the green color and the image for the blue color are formed respectively.

The image for the red color formed by the light transmitting area 71, that is, the red light (R) from the light transmitting area 71 enters the light collecting unit 2.

The image for the green color formed by the light transmitting area 72, that is, the green light (G) from the light transmitting area 72 enters the light collecting unit 2, and the image for the blue color formed by the light transmitting area 73, that is, the blue light (B) from the light transmitting area 73 enters the light collecting unit 2.

The red light (R), the green light (G) and the blue light (B) which have entered the light collecting unit 2 are collected (combined) as described above, whereby a color image is formed. The image is projected (enlarged and projected) on a screen 320 provided at a predetermined position by the projecting lens 40.

In the projector type display device 1, the white light entered the light splitting unit 3 is adapted so that the green light (G) proceeds straight, the red light (R) is split in the y-axis positive direction in FIG. 1 with respect to the green light (G), and the blue light (B) is split in the y-axis negative direction with respect to the green light (G). However, the invention is not limited thereto, and the white light may be adapted to be split with the respective single color lights counterchanged from each other.

### Second Embodiment

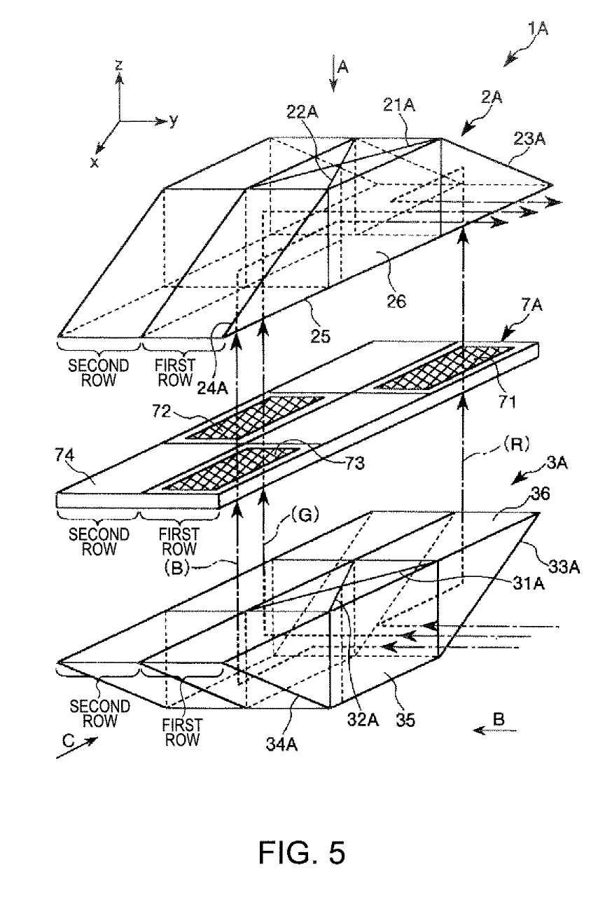

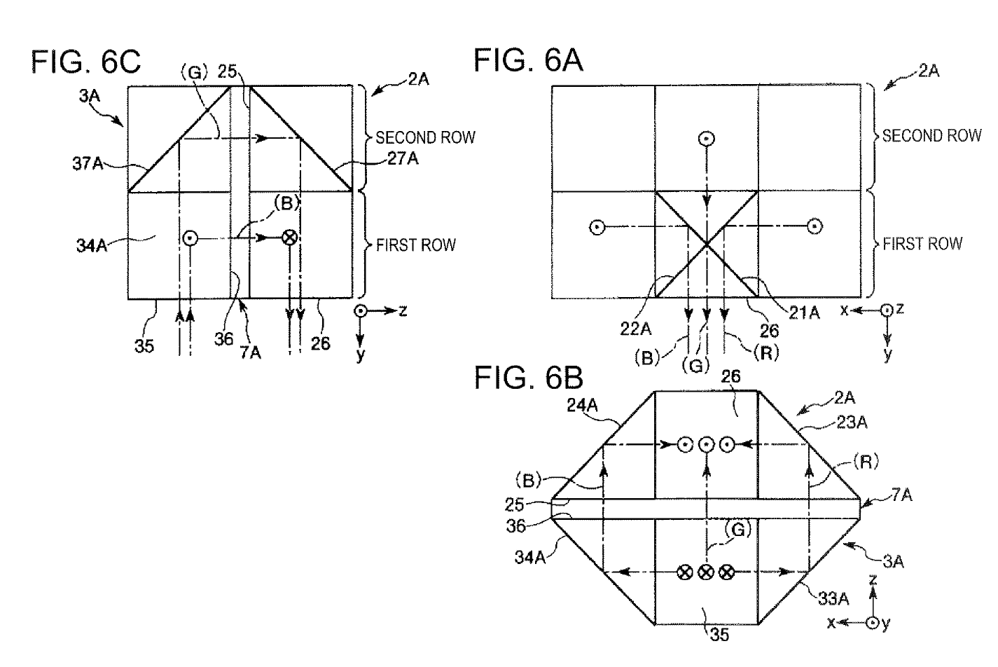

FIG. 5 is a pattern perspective view of the light splitting unit, the light collecting unit and the liquid crystal panel (second embodiment) of the projector type display device (second embodiment) according to an aspect of the invention, and FIG. 6A, FIG. 6B and FIG. 6C illustrate three views of the light splitting unit, the light collecting unit and the liquid crystal panel shown in FIG. 5 (in which FIG. 6A is a plan view viewed in the direction of an arrow A in FIG. 5, FIG. 6B is a front view viewed in the direction of an arrow B in FIG. 5, and FIG. 6C is a side view viewed in the direction of an arrow C in FIG. 5).

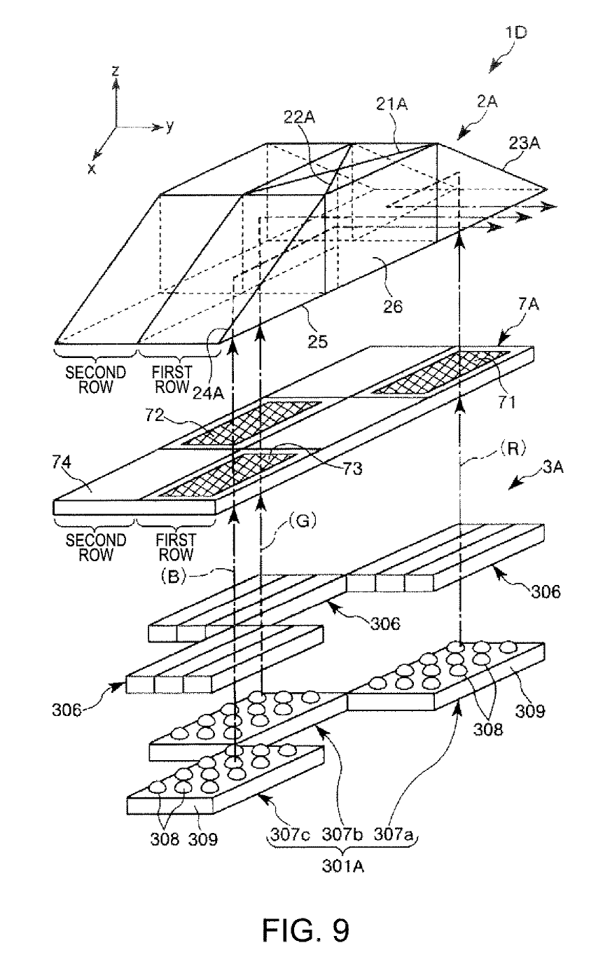

In FIG. 5 (also in FIG. 9), the light splitting unit, the light collecting unit and the liquid crystal panel are apart from each other, and the extent of distance is exaggerated in the drawing. In FIG. 5 and FIG. 6A to FIG. 6C (also in FIG. 9), the mounting portion is omitted. The upward/downward direction in FIG. 5 (the direction of the thickness of the liquid crystal panel in the mounted state) is referred to as the z-axis direction, a direction vertical to the z-axis direction (longitudinal direction of the liquid crystal panel in the mounted state) is referred to as the x-axis direction, and a direction vertical to the x-axis direction and the z-axis direction (the direction of the width of the liquid crystal panel in the mounted state) is referred to as the y-direction.

Referring now to these drawings, a second embodiment of the liquid crystal panel and the projector type display device according to an aspect of the invention will be described. In the description, the different points from the above-described embodiment are mainly described, and description of the same respects is omitted.

The second embodiment is the same as the first embodiment other than the configuration of the light splitting unit and the light collecting unit of the projector type display device and the arrangement of the respective light transmitting areas of the liquid crystal panel.

As shown in FIG. 5, in a liquid crystal panel 7A, the light transmitting area 71, 72 and 73 are arranged in a checkered manner.

In other words, in the liquid crystal panel 7A, the light transmitting areas 71, 72 and 73 are arranged in two rows along the x-axis direction in plan view. In this arrangement, the light transmitting areas 71 and 73 are arranged so as to be apart from each other in a first row. The light transmitting areas 71 and 73 are arranged so that the longitudinal sides thereof extend in parallel with the y-axis direction, and the shorter sides extend in parallel with the x-axis direction. In a second row, the light transmitting area 72 is arranged between the light transmitting area 71 and the light transmitting area 73. In other words, the light transmitting area 72 is arranged so that the longitudinal sides extend in parallel with the x-axis direction and the shorter sides extend in parallel with the y-axis direction as if the light transmitting area 73 is inverted by 90°. Hereinafter, the row on the light transmitting areas 71 and 73 of the liquid crystal panel 7A are referred to as the “first row”, and the row on the side of the light transmitting area 72 is referred to as the “second row”.

The liquid crystal panel 7A in this arrangement is configured in such a manner that red light (R) passes through the light transmitting area 71, green light (G) passes through the light transmitting area 72, and blue light (B) passes through the light transmitting area 73 in the mounted state (for example, see FIG. 5).

Subsequently, referring to FIG. 5 and FIG. 6A to FIG. 6C, a light splitting unit 3A of the projector type display device 1A in this embodiment will be described.

The light splitting unit 3A includes dichroic mirrors 31A, 32A and 37A, and mirrors 33A and 34A.

The dichroic mirror 31A is a mirror which reflects only blue light (B) (allows red light (R) and green light (G) to pass through).

The dichroic mirror 31A is provided in the first row of the light splitting unit 3A, and is arranged so as to incline by 45° in FIG. 5 with respect to the incident surface 35 of the light splitting unit 3A.

Only blue light (B) reflects in the x-axis positive direction by the dichroic mirror 31A in this arrangement.

The dichroic mirror 32A is a mirror which reflects only red light (R) (allows green light (G) and blue light (B) to pass through).

The dichroic mirror 32A is arranged in the first row of the light splitting unit 3A as in the case of the dichroic mirror 31A, and the midsection of the dichroic mirror 32A is oriented orthogonally to the midsection of the dichroic mirror 31A. Accordingly, only the red light (R) reflects in the x-axis negative direction.

The mirror 33A is provided in the direction of reflection of the dichroic mirror 32A. The mirror 33A is arranged so as to incline by 45° with respect to the x-axis direction (for example, see FIG. 61B). Accordingly, the red light (R) reflected from the dichroic mirror 32A is reflected by the mirror 33A in the z-axis positive direction and is emitted from the outgoing surface 36.

The red light (R) emitted from the outgoing surface 36 passes through the light transmitting area 71 of the liquid crystal panel 7A in the mounted state (see FIG. 5).

The mirror 34A is provided in the direction of reflection of the dichroic mirror 31A. The mirror 34A is arranged so that an angle formed with respect to the mirror 33A is 90° (for example, see FIG. 63). Accordingly, the blue light (B) reflected from the dichroic mirror 31A is reflected by the mirror 34A in the z-axis positive direction, and is emitted from the outgoing surface 36

The blue light (B) emitted from the outgoing surface 36 passes through the light transmitting area 73 of the liquid crystal panel 7A in the mounted state (see FIG. 5).

The dichroic mirror 37A is a mirror which reflects only green light (G) passed through the dichroic mirrors 31A and 32A. The dichroic mirror 37A is provided in the second row of the light splitting unit 3A, and is arranged so as to incline by 45° with respect to the incident surface 35 of the light splitting unit 3A (see FIG. 6C).

The green light (G) is reflected in the z-axis positive direction by the dichroic mirror 37A in this arrangement and is emitted from the outgoing surface 36.

The green light (G) emitted from the outgoing surface 36 passes through the light transmitting area 72 of the liquid crystal panel 7A in the mounted state (see FIG. 5).

In the configuration of the light splitting unit 3A as described above, the white light incoming into the light splitting unit 3A is split into the red light (R), the green light (G) and the blue light (B) and the respective single color lights enter the liquid crystal panel 7A in the split state.

Subsequently, referring to FIG. 5 and FIG. 6A to FIG. 6C, a light collecting unit 2A of the projector type display device 1A will be described.

The light collecting unit 2A includes dichroic mirrors 21A, 22A and 27A, and mirrors 23A and 24A.

The mirror 23A is located in the direction of reflection of the mirror 33A of the light splitting unit 3A. The mirror 23A is disposed so as to incline by 45° with respect to the incident surface 25, that is, so as to incline by 90° with respect to the mirror 33A of the light splitting unit 3A (see FIG. 6B).

With the mirror 23A arranged in this manner, the red light (R) emitted from the outgoing surface 36 of the light splitting unit 3A is reflected by the mirror 23A in the x-axis negative direction, and enters the dichroic mirror 22A (see FIG. 6A).

The dichroic mirror 22A is a mirror which reflects only red light (R) (allows green light (G) and blue light (B) to pass through).

The dichroic mirror 22A is provided in the first row of the light collecting unit 2A and is arranged so as to incline by 45° in the x-axis direction and the y-axis direction. Accordingly, the red light (R) reflected from the dichroic mirror 22A is reflected in the y-axis positive direction and is emitted from the outgoing surface 26.

The mirror 24A is located in the direction of reflection of the mirror 34A of the light splitting unit 3A. The mirror 24A is disposed so as to incline by 45° with respect to the incident surface 25, that is, so as to incline by 90° with respect to the mirror 34A of the light splitting unit 3A (see FIG. 6B).

With the mirror 24A arranged in this manner, the blue light (B) emitted from the outgoing surface 36 of the light splitting unit 3A is reflected by the mirror 24A in the x-axis negative direction, and enters the dichroic mirror 21A.

The dichroic mirror 21A is a mirror which reflects only blue light (B) (allows red light (R) and green light (G) to pass through).

The dichroic mirror 21A is provided in the first row of the light collecting unit 2A in the same manner as the dichroic mirror 22A, and the midsection of the dichroic mirror 21A is oriented orthogonally to the midsection of the dichroic mirror 22A (see FIG. 6A). Accordingly, the blue light (B) reflected from the dichroic mirror 21A is reflected in the y-axis positive direction, and emitted from the outgoing surface 26.

The dichroic mirror 27A is a mirror which reflects only green light (G). The dichroic mirror 27A is arranged in the second row of the light collecting unit 2A so as to incline by 45° with respect to the incoming surface 25, that is, so as to incline by 90′ with respect to the dichroic mirror 37A of the light splitting unit 3A (for example, see FIG. 6C).

With the dichroic mirror 27A in this arrangement, the green light (G) is reflected in the y-axis positive direction, and passes through the dichroic mirrors 21A and 22A, and is emitted from the outgoing surface 36.

With the configuration of the light collecting unit 2A, the red light (R), the green light (G) and the blue light (B) which enter the light collecting unit 2A in the split state are combined and emitted in this state.

In the projector type display device 1A, the lengths of the optical path of the red light (R) and the green light (G) which have passed through the light splitting unit 3A, the liquid crystal panel 7A and the light collecting unit 2A in sequence are set to be the same to each other (for example, see FIG. 5) as the dichroic mirrors 31A, 32A and 37A and the mirrors 33A and 34A of the light splitting unit 3A are arranged as described above, and the dichroic mirrors 21A, 22A and 27A and the mirrors 23A and 24A of the light collecting unit 2A are arranged as described above. Accordingly, a clear image can be obtained.

In the projector type display device 1A, the white light entered the light splitting unit 3A is adapted so that the green light (G) proceeds straight, the red light (R) is split in the x-axis negative direction in FIG. 5 with respect to the green light (G), and the blue light (B) is split in the x-axis positive direction with respect to the green light (G). However, the invention is not limited thereto, and the white light may be adapted to be split with the respective single color lights counterchanged from each other.

### Third Embodiment

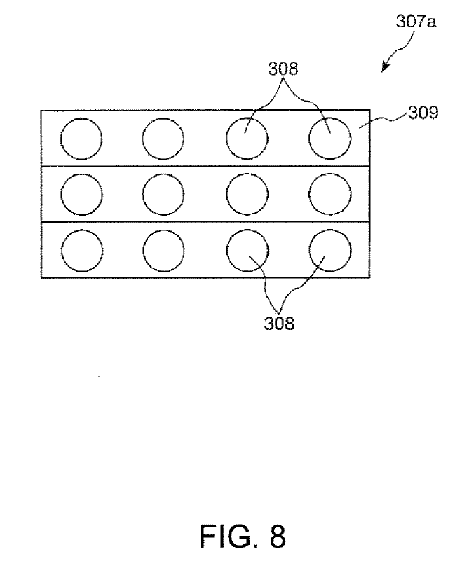

FIG. 7 is a pattern diagram of an optical system of the projector type display device (third embodiment) according to an aspect of the invention, and FIG. 8 is a plan view of a light source of the projector type display device shown in FIG. 7.

Referring now to the drawings, the projector type display device according to the third embodiment of the invention will be described. In the description, the different points from the above-described embodiments are mainly described, and description of the same respects is omitted.

The third embodiment is the same as the first embodiment other than the configuration of the light source.

An illumination optical system 30A of a projector type display device 1B shown in FIG. 7 includes a light source 301A and three diffuser panels 306. In the projector type display device 1B, the light splitting unit 3 provided in the projector type display device 1 in the first embodiment is omitted.

The light source 301A includes single color light sources 307a, 307b and 307c which emit single color lights having different wavelengths from each other, that is, red light (R), green light (G) and blue light (B) respectively. The single color light source 307a emits red light (R). The single color light source 307b emits green light (G). The single color light source 307c emits blue light (B).

In the projector type display device 1B, the single color light sources 307a, 307b and 307c are arranged in sequence in the y-axis direction, that is, along the longitudinal direction of the liquid crystal panel 7. Accordingly, in the same manner as the light splitting unit 3 which splits the white light, the red light (R), the green light (G) and the blue light (B) enters the liquid crystal panel 7 and the light collecting unit 2 respectively in sequence.

In this manner, in the projector type display device 1B, the light splitting unit 3 is omitted, that is, the configuration can be simplified. In addition, the light source 301A can be disposed in the vicinity of the liquid crystal panel 7, whereby the length of the optical path of the respective single color lights can be reduced to a relatively short length.

Since the single color light sources 307a, 307b and 307c have substantially the same configuration, the single color light source 307a will be described as a representative.

As shown in FIG. 8, the single color light source 307a includes a plurality of light-emitting diodes 308, and a substrate (circuit board) 309 for supporting the respective light-emitting diode 308.

The substrate 309 is configured of a plate-shaped member of a rectangular shape in plan view.

In the single color light source 307a, the plurality of light-emitting diodes 308 are arranged in rows on the substrate 309. In the configuration shown in FIG. 8, the three light-emitting diodes 308 are arranged along the direction of the width of the substrate 309, and the four light-emitting diodes 308 are arranged along the longitudinal direction of the substrate 309. In other words, in the configuration in FIG. 8, the plurality of light-emitting diodes 308 are arranged in three rows and four columns.

Since the plurality of light-emitting diodes 308 are arranged as described above, light from the single color light source 307a can be irradiated uniformly on the light transmitting area 71 of the liquid crystal panel 7. Accordingly, the image obtained on the screen 320 becomes clearer.

The diffuser panel 306 is disposed on the outgoing side of the single light source 307a (the same for the single color light sources 307b and 307c), that is, between the single color light source 307a and the liquid crystal panel 7 (mounting portion 4). The light from the single color light source 307a is diffused by the diffuser plate 306, whereby the light from the single color light source 307a can be irradiated further uniformly on the light transmitting area 71 of the liquid crystal panel 7. The illumination intensity in the light transmitting area 71 of the liquid crystal panel 7 can be uniformized.

The light-emitting diode 308 has generally long lifetime in comparison with the light source which emits, for example, white light. Accordingly, the number of times of repair or replacement of the single color light source 307a required, for example, due to failure, that is, MTBF or MTTF of the single color light source 307a can be set to a relatively long time.

The light-emitting diode 308 is turned ON and OFF quickly with respect to, for example, the light source which emits white light.

The number of rows and columns of the plurality of light-emitting diodes 308 in the single color light source 307a (the same in the single color light sources 307b and 307c) is not limited to the number described above, as a matter of course.

### Fourth Embodiment

FIG. 9 is a pattern perspective view showing the light collecting unit, the liquid crystal panel, and the light source of the projector type display device (fourth embodiment) according to an aspect of the invention.

Referring now to the drawing, the projector type display device according to the fourth embodiment of the invention will be described. In the description, the different points from the above-described embodiments are mainly described, and description of the same respects is omitted.

This embodiment is the same as the second embodiment other than the configuration of the light source.

in a projector type display device 1D shown in FIG. 9, the single color light sources 307a, 307b and 307c are arranged corresponding to the respective light transmitting areas 71, 72 and 73 of the liquid crystal panel 7A, that is, in a checkered manner. The single color light source 307a is positioned below (in the z-axis negative direction) of the light transmitting area 71. The single color light source 307b is positioned below the light transmitting area 72. The single color light source 307c is positioned below the light transmitting area 73.

The diffuser plates 306 are interposed between the respective single color light sources 307a, 307b and 307c and the liquid crystal panel 7A, respectively.

In this configuration, as in the case of the second embodiment, the lengths of the optical path of red light (R), green light (G) and blue light (B) which have passed through the diffuser panel 306, the liquid crystal panel 7A, and the light collecting unit 2A in sequence can be set to be the same to each other. Accordingly, the clear image can be obtained.

Although the liquid crystal panel and the projector type display device according to some aspects of the invention have been described on the basis of the embodiments shown in the drawings, the invention is not limited thereto, and the respective portions which constitutes the liquid crystal panel and the projector type display device can be replaced by those with arbitrary configurations which can demonstrate the same function, and the optional structure may be added.

The liquid crystal panel and the projector type display device according to some aspects of the invention may be those obtained by combining two or more arbitrary configurations (characteristics) out of the respective embodiments shown above.

For example, the projector type display device in the first embodiment may be configured in such a manner that the liquid crystal panel in the second embodiment can be mounted.]

The entire disclosure of Japanese Patent Application Nos. 2005-295968, filed Oct. 11, 2005 and 2006-171006, filed Jun. 21, 2006 are expressly incorporated by reference herein.

What is claimed is:

1. A liquid crystal panel to be demountably mounted to a projector type display device having a light source for emitting light and a light collecting unit collecting a plurality of single color lights out of the light emitted from the light source at a position between the light source and the light collecting unit, the liquid crystal panel comprising:
a plurality of light transmitting areas for allowing the respective single color lights to pass through in the state of being mounted to the projector type display device,
wherein the plurality of light transmitting areas are arranged and connected or integrated in a direction of substantially the same plane of the liquid crystal panel.

2. The liquid crystal panel according to claim 1, wherein the plurality of single color lights are respectively red color, green color and blue color, and three of the light transmitting areas are provided corresponding to the respective lights.

3. The liquid crystal panel according to claim 1, wherein the liquid crystal panel is formed substantially into an elongated shape in its entirety.

4. The liquid crystal panel according to claim 3, wherein the plurality of light transmitting areas are arranged in a row along the longitudinal direction of the liquid crystal panel.

5. The liquid crystal panel according to claim 1, wherein the plurality of light transmitting areas are arranged in a checkered manner.

6. The liquid crystal panel according to claim 1, wherein the liquid crystal panel is formed into an elongated shape in its entirety, and the mounting direction thereof with respect to the projector type display device substantially corresponds to the longitudinal direction of the liquid crystal panel.

7. The liquid crystal panel according to claim 1, wherein the liquid crystal panel is operated on the basis of image signal from the projector type display device and an image is formed thereby.

8. A projector type display device in which a liquid crystal panel having a plurality of light transmitting areas through which a plurality of single color lights pass respectively is mounted, the plurality of light transmitting areas being arranged and connected or integrated in a direction of substantially the same plane, comprising:
a light source emitting light,
a light collecting unit for collecting a plurality of single color lights out of light emitted from the light source, and
a mounting portion provided between the light source and the light collecting unit mounting the liquid crystal panel so as to be mountable and demountable.

9. The projector type display device according to claim 8, wherein the light source includes a plurality of single color light sources which emit single color lights being different in wavelength from each other.

10. The projector type display device according to claim 8, wherein the light source emits white light, and a light splitting unit installed so as to oppose the light collecting unit via the mounting portion for splitting the white light emitted from the light source into a plurality of single color lights.

11. The projector type display device according to claim 10, wherein the mounting portion includes a positioning unit that determines the position of the liquid crystal panel mounted to the mounting portion with respect to the light splitting unit and/or the light collecting unit, respectively.

12. The projector type display device according to claim 10, wherein the light splitting unit includes a plurality of dichroic mirrors corresponding to the respective single color lights and the dichroic mirrors are connected or integrated.

13. The projector type display device according to claim 10, wherein the light splitting unit comprises a first dichroic mirror group in which a plurality of dichroic mirrors corresponding to the respective single color lights are included and the dichroic mirrors are connected or integrated,
the light collecting unit comprises a second dichroic mirror group in which a plurality of dichroic mirrors corresponding to the respective single color lights are included and the dichroic mirrors are connected or integrated, and
the first dichroic mirror group and the second dichroic mirror group are arranged so that the lengths of the respective optical paths of the plurality of single color lights become the same.

14. The projector type display device according to claim 8, wherein the light source includes a light-emitting diode.

15. The projector type display device according to claim 14, wherein a plurality of the light-emitting diodes are provided and are arranged in rows and columns.

16. The projector type display device according to claim 8, wherein the plurality of single color lights are red light, green light and blue light, respectively.

17. The projector type display device according to claim 8, wherein the mounting portion includes a frame-shaped mounting portion main body for supporting the liquid crystal panel mounted to the mounting portion, and a guide portion formed along the mounting portion main body along a direction of mounting the liquid crystal panel for guiding the liquid crystal panel in this direction.

18. The projector type display device according to claim 8, wherein the mounting portion includes a friction alleviating unit alleviating friction between the liquid crystal panel and the guide portion when the liquid crystal panel is mounted.

19. The projector type display device according to claim 8, wherein the light collecting unit includes a plurality of dichroic mirrors corresponding to the respective single color lights, and the dichroic mirrors are connected or integrated.

20. The projector type display device according to claim 8 comprising an optical path length adjusting unit that adjusts the length of the optical path so that the lengths of the optical paths of the plurality of single color lights become the same.
